(19) United States
(12) Patent Application Publication
(10) Pub. No.: US 2009/0023870 A1
(43) Pub. Date: Jan. 22, 2009

(54) Method of Pultrusion Employing Multiple Resins

(75) Inventors: Ebise Mualla Berksoy, Edmonton (CA); David Slaback, St. Albert (CA)

Correspondence Address: Marina Larson & Associates, LLC, P.O. BOX 4928, DILLON, CO, 80435, US

(73) Assignee: RESIN SYSTEMS, INC, Calgary, AB (CA)

(21) Appl. No.: 12/278,434

(22) PCT Filed: Aug. 4, 2006
(86) PCT No.: PCT/CA06/01297

§ 371 Date: Aug. 22, 2008

(30) Foreign Application Priority Data
Feb. 7, 2006 (CA) PCT/CA2006/000162

(51) Int. Cl. C08G 18/32; B29C 70/52

(52) U.S. Cl. 525/453; 156/166

(57) ABSTRACT

There is provided a method of pultrusion using multiple resins. In the method a continuous interior reinforcement layer and a continuous exterior reinforcement layer are supplied and the interior reinforcement layer is infused with a first resin and then combined with the exterior reinforcement layer to form a pultrusion reinforcement structure. The pultrusion reinforcement structure passes into an infusion die where a second resin infuses the exterior reinforcement layer, and then passes into a curing die to cure the resins and form a composite article. The second resin comprises an aliphatic isocyanate polyurethane resin with a greater concentration of aliphatic isocyanate than is present in the first resin to give the composite article superior UV resistance. A pultruded composite article produced by the pultrusion method is also provided.

### FIELD OF INVENTION

The present invention relates generally a method of pultrusion employing multiple resins and more particularly, to a method of manufacturing a composite article by pultrusion.

### BACKGROUND OF THE INVENTION

Pultrusion of resin-impregnated or infused fibres, such as mineral or glass fibres, is well known. Generally, pultrusion of resin impregnated fibres involves impregnating a multitude of continuous fibres and/or continuous fibre/mat combinations with a suitable resin material and passing the impregnated fibres through a die where the fibres are formed into a desired shaped and the resin material cured to fix the fibres in place.

The continuous fibres may be infused by passing the fibres through a bath of liquid resin material, thereby completely wetting or coating the fibres in the resin material. Alternatively, resin injection may be used as a means for infusing continuous fibres in a pultrusion process using a machined cavity in a die. As dry fibre is fed through the die and into the cavity, resin is injected such that the fibres are coated with resin material. This process may take place at atmospheric or elevated pressure.

U.S. Pat. No. 5,783,013 to Beckman et al. discloses a method for performing resin-injected pultrusion employing different resin materials. The method comprises impregnating interior layers of a pultrusion reinforcement pack with a first resin material, adding an exterior layers to form a pultrusion pack and impregnating the pack with a resin material substantially non-identical to the first resin material. The resin impregnated reinforcement pack is then passed to a curing die to cure the resin materials. It is disclosed that the non-identical first and second resin materials employed may impart different properties to the interior layers and the exterior layers. For example, a pultruded part intended for use as a motor vehicle bumper beam, may include interior layers impregnated with a strength imparting resin while the outer layers are impregnated with a flexibility imparting resin so that those layers are capable of absorbing high quantities of energy resulting from an impact. Also, a pultruded part intended for use as a chemical mixing blade may be impregnated with a second resin material, which comprises a chemical resistance imparting resin, and the interior layers may be impregnated with a strength imparting resin. This disclosure does not address the use of polyurethane resins and in particular there is no mention of using a polyurethane resin comprising an aliphatic isocyanate.

Polyurethane resin has been utilized in the pultrusion industry for less than 10 years. Polyurethane resins are a family of resins that contain a significant number of urethane linkages within its molecular chains. Polyurethane resins are produced by reacting an isocyanate group with an organic compound containing hydrogen atoms that are attached to atoms more electronegative than carbon, such as polyols, in predetermined proportions, which react under the influence of heat or certain catalysts to form a polymer. If significant cross-linking occurs, the result is a thermosetting material. As a matrix material in fibre reinforced plastics (FRPs) or composite materials, polyurethane resin has shown tremendous physical properties, particularly in the transverse direction.

Aromatic polyisocyanate is the most widely used isocyanate component for polyurethane resins employed to manufacture composite articles, due to its strength properties and economic value. The resulting aromatic isocyanate composite material however, is prone to turn yellow on exposure to UV radiation. The colour integrity of an aromatic isocyanate composite material quickly diminishes and eventually the resin property of the composite will be weakened after prolonged UV exposure and weathering. Therefore, polyurethane composite articles, especially those utilized in the outdoor environment that are exposed to prolonged periods of UV radiation and other weathering (such as, but not limited to utility poles) require extra protection.

Various attempts have been made to maintain the colour and integrity of aromatic isocyanate based polyurethane composite articles, for example, by brush painting, spray painting, roller painting and powder coating the articles with various paint types that are typically resistant to UV radiation. However, these attempts have found little acceptance in view of the expense, technical difficulties and questionable durability of these paints, especially when the polyurethane composite articles are large infrastructure products such as utility poles.

U.S. Pat. No. 6,420,493 to Ryckis-Kite et al. (which is incorporated herein by reference) describes the use of volatile organic compound (VOC) free polyurethane composite resins for composite materials. The polyurethane resins are made by mixing a polyol component and an isocyanate component. Aromatic and aliphatic isocyanates are disclosed. Although a VOC free aliphatic polyisocyanate has superior resistance to chemicals and ultra violet (UV) rays, it is typically much more expensive than a VOC free aromatic polyisocyanate. It is therefore taught in U.S. Pat. No. 6,420,493, that in order to obtain a balance between physical properties and cost a polyisocyanate component comprising a homogeneous blend of at least 15% by weight of an aliphatic polyisocyanate with the remainder being an aromatic polyisocyanate is used in the resin. There remains a need for a composite article with improved UV and scratch resistance produced by pultrusion.

### SUMMARY OF THE INVENTION

The present invention relates to a method of pultrusion employing multiple resins.

It is an object to provide a method of pultrusion and composite articles made by such method.

The present invention provides a method of manufacturing a composite article by pultrusion (Method A) comprising:
supplying a continuous interior reinforcement layer and a continuous exterior reinforcement layer;
infusing the interior reinforcement layer with a first resin to form an infused interior reinforcement layer;
combining the infused interior reinforcement layer with the exterior reinforcement layer to form a pultrusion reinforcement structure;
passing the pultrusion reinforcement structure into an infusion die and infusing the exterior reinforcement layer of the pultrusion reinforcement structure with a second resin to form an infused pultrusion reinforcement structure; and
passing the infused pultrusion reinforcement structure to a curing die to cure the first and second resin in the infused pultrusion reinforcement structure and form a composite article;
   wherein the second resin comprises a polyurethane resin comprising a polyol component and an isocyanate component, and the concentration of aliphatic isocyanate in the isocyanate component is greater than the concentration of aliphatic isocyanate in the first resin.

The present invention pertains to a method of manufacturing a composite article by pultrusion as just defined (Method A) wherein the step of passing the pultrusion reinforcement structure into the infusion die comprises the steps of shaping and compressing the pultrusion reinforcement structure.

The present invention pertains to a method of manufacturing a composite article by pultrusion as just defined (Method A) wherein the curing die is sealingly coupled to the infusion die and in the step of passing the infused pultrusion reinforcement structure to the curing die the infused pultrusion reinforcement structure is maintained under compression.

The present invention pertains to a method of manufacturing a composite article by pultrusion as just defined (Method A) wherein the step of infusing the interior reinforcement layer with the first resin comprises passing the interior reinforcement layer into a further infusion die and infusing the interior reinforcement layer with the first resin to form the infused interior reinforcement layer. The step of passing the interior reinforcement layer into the further infusion die may comprise the steps of shaping and compressing the interior reinforcement layer.

The present invention pertains to a method of manufacturing a composite article by pultrusion as just defined (Method A) wherein the first resin may contain no aliphatic isocyanate. The first resin may comprise a polyurethane resin (first polyurethane resin) and the infused interior reinforcement layer may comprise from about 20 to about 85% by weight, or any amount therebetween, of the reinforcement and from about 15 to about 80% by weight, or any amount therebetween of the first polyurethane resin. The first polyurethane resin may comprise from about 20 to about 80% by weight, or any amount therebetween, of an aromatic polyisocyanate and from about 20 to about 80% by weight, or any amount therebetween, of a polyol, or a blend of polyols. Other polyisocyanates may be present in the first polyurethane resin, for example, the first polyurethane resin may comprise from about 0% to about 40% by weight, or any amount therebetween, of an aliphatic polyisocyanate, provided that the concentration of aliphatic isocyanate in the second resin is greater than the concentration of aliphatic isocyanate in the first polyurethane resin. The first polyurethane resin may have an OH/NCO weight ratio from about 0.1:1 to about 5:1 (preferably from about 0.4:1 to about 1.5:1), or any amount therebetween. The first polyurethane resin may further comprise a catalyst selected from the group consisting of tin, bismuth, zinc, titanium and mixtures thereof.

The present invention pertains to a method of manufacturing a composite article by pultrusion as just defined (Method A) wherein the infused exterior reinforcement layer of the infused pultrusion reinforcement structure may comprise from about 20 to about 85% by weight, or any amount therebetween, of the reinforcement and from about 15 to about 80% by weight, or any amount therebetween of the second resin. The second resin may comprise from about 20 to about 80% by weight, or any amount therebetween, of the isocyanate component and from about 20 to about 80% by weight, or any amount therebetween, of the polyol component. The isocyanate component may comprise at least 15 weight percent of an aliphatic polyisocyanate to give the required characteristics of UV stability and abrasion resistance. Other polyisocyanates may be present in the isocyanate component, for example, the reaction mixture may comprise from about 0% to about 40% by weight, or any amount therebetween, of an aromatic polyisocyanate, provided that the concentration of aliphatic isocyanate in the second resin is greater than the concentration of aliphatic isocyanate in the first resin. The second resin may have an OH/NCO weight ratio from about 0.1:1 to about 5:1 (preferably from about 0.4:1 to about 1.5:1), or any amount therebetween. The second resin may further comprise a catalyst selected from the group consisting of tin, bismuth, zinc, titanium and mixtures thereof.

The present invention pertains to a method of manufacturing a composite article by pultrusion as just defined (Method A) wherein the isocyanate component comprises hexamethylene diisocyanate (HDI), isophorone diisocyanate (IPDI) or a mixture thereof. Preferably the isocyanate component comprises a mixture of aliphatic hexane 1,6-diisocyanato-homopolymer and hexamethylene diisocyanate (HDI).

The present invention pertains to a method of manufacturing a composite article by pultrusion as just defined (Method A) wherein the polyol component comprises from about 60 to about 100 weight percent polyether polyol and from about 0 to about 40 weight percent polyester polyol. The polyether polyol may have an equivalent weight in the range from about 70 to about 2500 and a hydroxyl functionality equal to or greater than about 2. Preferably the polyether polyol has an equivalent weight in the range from about 70 to about 400 and an hydroxyl functionality in the range from about 2 to about 6. The polyester polyol may have an equivalent weight in the range from about 70 to about 1000 and an hydroxyl functionality equal to or greater than about 2. Preferably the polyester polyol has an equivalent weight in the range from about 100 to about 300 and an hydroxyl functionality in the range from about 2 to about 6.

The present invention provides a method of manufacturing a composite article by pultrusion (Method B) comprising:
supplying a continuous interior reinforcement layer and a continuous exterior reinforcement layer;
passing the interior reinforcement layer into a first infusion die and infusing the interior reinforcement with a first resin to form an infused interior reinforcement layer;
combining the infused interior reinforcement layer with the exterior reinforcement layer to form a pultrusion reinforcement structure;
passing the pultrusion reinforcement structure into a second infusion die and infusing the exterior reinforcement layer of the pultrusion reinforcement structure with a second resin to form an infused pultrusion reinforcement structure; and
passing the infused pultrusion reinforcement structure to a curing die to cure the first and second resin in the infused pultrusion reinforcement structure to form a composite article;
   wherein the second resin comprises a polyurethane resin comprising a polyol component and an isocyanate component, and the concentration of aliphatic isocyanate in the isocyanate component is greater than the concentration of aliphatic isocyanate in the first resin.

The present invention pertains to a method of manufacturing a composite article by pultrusion as just defined (Method B) wherein the step of passing the interior reinforcement layer into the first infusion die comprises the steps of shaping and compressing the interior reinforcement layer. Furthermore, the step of passing the pultrusion reinforcement structure into the second infusion die may comprise the steps of shaping and compressing the pultrusion reinforcement structure.

The present invention pertains to a method of manufacturing a composite article by pultrusion as just defined (Method B) wherein the curing die is sealingly coupled to the second infusion die and in the step of passing the infused pultrusion reinforcement structure to the curing die the infused pultrusion reinforcement structure is maintained under compression.

The present invention pertains to a method of manufacturing a composite article by pultrusion as just defined (Method B) wherein the first resin may contain no aliphatic isocyanate. The first resin may comprise a polyurethane resin (first polyurethane resin) and the infused interior reinforcement layer may comprise from about 20 to about 85% by weight, or any amount therebetween, of the reinforcement and from about 15 to about 80% by weight, or any amount therebetween of the first polyurethane resin. The first polyurethane resin may comprise from about 20 to about 80% by weight, or any amount therebetween, of an aromatic polyisocyanate and from about 20 to about 80% by weight, or any amount therebetween, of a polyol, or blend of polyols. Other polyisocyanates may be present in the first polyurethane resin, for example, the first polyurethane resin may comprise from about 0% to about 40% by weight, or any amount therebetween, of an aliphatic polyisocyanate, provided that the concentration of aliphatic isocyanate in the second resin is greater than the concentration of aliphatic isocyanate in the first polyurethane resin. The first polyurethane resin may have an OH/NCO weight ratio from about 0.1:1 to about 5:1 (preferably from about 0.4:1 to about 1.5:1), or any amount therebetween. The first polyurethane resin may further comprise a catalyst selected from the group consisting of tin, bismuth, zinc, titanium and mixtures thereof.

The present invention pertains to a method of manufacturing a composite article by pultrusion as just defined (Method B) wherein the infused exterior reinforcement layer of the infused pultrusion reinforcement structure may comprise from about 20 to about 85% by weight, or any amount therebetween, of the reinforcement and from about 15 to about 80% by weight, or any amount therebetween of the second resin. The second resin may comprise from about 20 to about 80% by weight, or any amount therebetween, of the isocyanate component and from about 20 to about 80% by weight, or any amount therebetween, of the polyol component. The isocyanate component may comprise at least 15 weight percent of an aliphatic polyisocyanate to give the required characteristics of UV stability and abrasion resistance. Other polyisocyanates may be present in the isocyanate component, for example, the reaction mixture may comprise from about 0% to about 40% by weight, or any amount therebetween, of an aromatic polyisocyanate, provided that the concentration of aliphatic isocyanate in the second resin is greater than the concentration of aliphatic isocyanate in the first resin. The second resin may have an OH/NCO weight ratio from about 0.1:1 to about 5:1 (preferably from about 0.4:1 to about 1.5:1), or any amount therebetween. The second resin may further comprise a catalyst selected from the group consisting of tin, bismuth, zinc, titanium and mixtures thereof.

The present invention pertains to a method of manufacturing a composite article by pultrusion as just defined (Method B) wherein the isocyanate component comprises hexamethylene diisocyanate (HDI), isophorone diisocyanate (IPDI) or a mixture thereof. Preferably the isocyanate component comprises a mixture of aliphatic hexane 1,6-diisocyanato-homopolymer and hexamethylene diisocyanate (HDI).

The present invention pertains to a method of manufacturing a composite article by pultrusion as just defined (Method B) wherein the polyol component comprises from about 60 to about 100 weight percent polyether polyol and from about 0 to about 40 weight percent polyester polyol. The polyether polyol may have an equivalent weight in the range from about 70 to about 2500 and a hydroxyl functionality equal to or greater than about 2. Preferably the polyether polyol has an equivalent weight in the range from about 70 to about 400 and an hydroxyl functionality in the range from about 2 to about 6. The polyester polyol may have an equivalent weight in the range from about 70 to about 1000 and an hydroxyl functionality equal to or greater than about 2. Preferably the polyester polyol has an equivalent weight in the range from about 100 to about 300 and an hydroxyl functionality in the range from about 2 to about 6.

The present invention further provides a pultruded composite article comprising an interior layer of a first composite material and an exterior layer of a second composite material, the concentration of aliphatic isocyanate in the second composite material being greater than the concentration of aliphatic isocyanate in the first composite material.

The present invention pertains to a composite article as just defined wherein the first composite material may comprise a resin with no aliphatic isocyanate therein. The first composite material may comprise from about 20 to about 85% by weight, or any amount therebetween, of a reinforcement and from about 15 to about 80% by weight, or any amount therebetween of a polyurethane resin. The polyurethane resin of the first composite material may comprise from about 20 to about 80% by weight, or any amount therebetween, of an aromatic polyisocyanate and from about 20 to about 80% by weight, or any amount therebetween, of a polyol, or blend of polyols. Other polyisocyanates may be present in the polyurethane resin of the first composite material, for example, the polyurethane resin may comprise from about 0% to about 40% by weight, or any amount therebetween, of an aliphatic polyisocyanate, provided that the amount of aliphatic isocyanate in the second composite material is greater than the amount of aliphatic isocyanate in the first composite material. The polyurethane resin of the first composite material may have a OH/NCO weight ratio from about 0.1:1 to about 5:1 (preferably from about 0.4:1 to about 1.5:1), or any amount therebetween.

The present invention pertains to a composite article as just defined wherein the second composite material may comprise from about 20 to about 85% by weight, or any amount therebetween, of a second reinforcement and from about 15 to about 80% by weight, or any amount therebetween of an aliphatic isocyanate polyurethane resin. The aliphatic isocyanate polyurethane resin of the second composite material may comprise from about 20 to about 80% by weight, or any amount therebetween, of an aliphatic polyisocyanate and from about 20 to about 80% by weight, or any amount therebetween, of a polyol, or blend of polyols. Other polyisocyanates may be present in the aliphatic isocyanate polyurethane resin of the second composite material, for example, the aliphatic isocyanate polyurethane resin may comprise from about 0% to about 40% by weight, or any amount therebetween, of an aromatic polyisocyanate, provided that the amount of aliphatic isocyanate in the aliphatic isocyanate polyurethane resin of the second composite material is greater than the amount of aliphatic isocyanate in the first composite material. The aliphatic isocyanate polyurethane resin of the second composite material may have a OH/NCO weight ratio from about 0.1:1 to about 5:1 (preferably from about 0.4:1 to about 1.5:1), or any amount therebetween.

The present invention pertains to a composite article as just defined wherein the composite article is produced using Method A of the present invention.

The present invention pertains to a composite article as just defined wherein the composite article is produced using Method B of the present invention.

The present invention pertains to a composite article as just defined wherein the composite article is a utility pole.

By manufacturing a composite article by pultrusion which has an exterior layer that comprises reinforcement embedded in a thermosetting polyurethane resin, the polyurethane resin characterized as having a concentration of an aliphatic isocyanate from about 20 to about 80% by weight, or any amount therebetween, and from about 20 to about 80% by weight, or any amount therebetween, of a polyol, the pultruded composite article is well suited for uses that involve UV exposure. Furthermore, by manufacturing a composite article by pultrusion which has an interior layer comprising reinforcement embedded in an aromatic isocyanate polyurethane, or other resin, for example, but not limited to, polyester, epoxy, or vinylester resin or mixtures thereof, with little or no aliphatic isocyanate polyurethane, the pultruded composite article maintains the strength and durability associated with pultruded composite articles, yet the cost of the pultruded composite article is significantly less than that of a pultruded composite article manufactured with a homogenous distribution of aliphatic isocyanate polyurethane throughout the article. Polyurethane resins have the additional advantage of typically being VOC free.

By using a method of pultrusion employing multiple resins and multiple separately infused reinforcement layers combined to form a pultrusion reinforcement structure, means thicker walled pultruded composite articles can be produced. The thickness of each reinforcement layer that can be used is limited, as proper infusion of the reinforcement with resin will not occur if the layer is too thick. However, provision of multiple reinforcement layers, each being separately infused with resin, enables a thicker composite article to be pultruded using the method of the present invention.

This summary of the invention does not necessarily describe all features of the invention.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 shows a schematic diagram of a pultrusion process in accordance with an embodiment of the present invention.

FIG. 2 shows a perspective view of a non-limiting example of a pultrusion apparatus suitable for performing a pultrusion process in accordance with an embodiment of the present invention.

FIG. 3 shows a cross-sectional view of a portion of the pultrusion apparatus illustrated in FIG. 2.

### DETAILED DESCRIPTION

The present invention relates to a method of pultrusion employing multiple resins.

The following description is of a preferred embodiment.

The present invention provides a method of manufacturing a composite article by pultrusion comprising:
supplying a continuous interior reinforcement layer and a continuous exterior reinforcement layer;
passing the interior reinforcement layer into a first infusion die and infusing the interior reinforcement with a first resin to form an infused interior reinforcement layer;
combining the infused interior reinforcement layer with the exterior reinforcement layer to form a pultrusion reinforcement structure;
passing the pultrusion reinforcement structure into a second infusion die and infusing the exterior reinforcement layer of the pultrusion reinforcement structure with a second resin to form an infused pultrusion reinforcement structure; and
passing the infused pultrusion reinforcement structure to a curing die to cure the first and second resin in the infused pultrusion reinforcement structure to form a composite article.

The second resin comprises a polyurethane resin comprising a polyol component and an isocyanate component, and the concentration of aliphatic isocyanate in the isocyanate component is greater than the concentration of aliphatic isocyanate in the first resin.

In a further embodiment of the present invention there is provided a pultruded composite article comprising an interior layer of a first composite material and an exterior layer of a second composite material, the concentration of aliphatic isocyanate in the second composite material being greater than the concentration of aliphatic isocyanate in the first composite material.

Aliphatic isocyanate polyurethane resin has superior resistance to weathering and UV rays, however aliphatic polyisocyanate polyurethane resin is generally much more expensive than other resins, such as, but not limited to, aromatic polyisocyanate polyurethane resin, polyester, epoxy, or vinylester resin or mixtures thereof. A pultruded composite article having an exterior layer of an aliphatic isocyanate polyurethane composite material and an interior layer made from a different composite material with a lower concentration of aliphatic isocyanate therein (and preferably no aliphatic isocyanate therein) advantageously possesses UV stability and superior abrasion resistance, while being less expensive to produce than a pultruded composite article manufactured with a homogenous distribution of aliphatic isocyanate polyurethane throughout the article. This is particularly beneficial for large pultruded composite articles that are to be utilized outside for long periods of time, such as, but not limited to, poles, pipes, posts, fencing materials, guard rails, scaffolding, building materials, and other materials that may be used outdoors.

Preferably, the exterior layer of polyurethane composite material binds to the interior layer of first resin composite material to provide an integral composite article.

The first resin may contain no aliphatic isocyanate and preferably comprises a polyurethane resin comprising an aromatic polyisocyanate and a polyol. Aromatic polyisocyanates are typically less expensive than aliphatic polyisocyanates and produce polyurethane composite material with good strength characteristics. A pultruded composite article with an aromatic isocyanate polyurethane composite interior layer and an exterior layer of aliphatic isocyanate polyurethane composite material has the combined advantages of strength, UV stability and abrasion resistance, while being economic to produce even when large composite articles are required, such as, but not limited to, utility poles, posts, poles, building and other structural materials.

The first resin may be a polyurethane resin (hereinafter referred to as first polyurethane resin) and the infused interior reinforcement layer may comprise from about 20 to about 85% by weight, or any amount therebetween, of the reinforcement, for example 22, 24, 26, 28, 30, 32, 34, 36, 38, 40, 42, 44, 46, 48, 50, 52, 54, 56, 58, 60, 62, 64, 66, 68, 70, 72, 74, 76, 78, 80 and 82 weight percent, or any amount therebetween, and from about 15 to about 80% by weight, or any amount therebetween of the first polyurethane resin, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76 and 78 weight percent, or any amount therebetween.

The first resin may comprise predominantly an aromatic isocyanate polyurethane resin, from about 20 to about 80% by weight, or any amount therebetween, of an aromatic polyisocyanate, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween, and from about 20 to about 80% by weight, or any amount therebetween, of a polyol, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween, Other polyisocyanates may be present in the first polyurethane resin, for example, the first polyurethane resin may comprise from about 0% to about 40% by weight, or any amount therebetween, of an aliphatic polyisocyanate, for example 2, 4, 6, 8, 10, 12, 14, 16, 18, 20, 22, 24, 26 28, 30, 32, 34, 36 and 38 weight percent, or any amount therebetween, provided that the concentration of aliphatic isocyanate in the isocyanate component of the second resin is greater than the concentration of aliphatic isocyanate in the first resin.

The first polyurethane resin may have a OH/NCO weight ratio from about 0.1:1 to about 5:1, or any amount therebetween, for example a ratio of 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2.0:1, 2.2:1, 2.4:1, 2.6:1, 2.8:1, 3.0:1, 3.2:1, 3.4:1, 3.6:1, 3.8:1, 4.0:1, 4.2:1, 4.4:1, 4.6:1, and 4.8:1, or any amount therebetween and preferably has a ratio from about 0.4:1 to about 1.5:1, or any amount therebetween, for example a ratio of 0.5:1, 0.6:1, 0.7:1, 0.8:1, 0.9:1, 1:1, 1.1:1, 1.2:1, 1.3:1 and 1.4:1,or any amount therebetween.

The first resin of the infused interior reinforcement layer may be allowed to set, or partially set, for example after reaching from about 30 to about 90%, or any amount therebetween of its hardness, before the step of combining the infused interior reinforcement layer with the exterior reinforcement layer to form a pultrusion reinforcement structure. Preferably, the second resin is applied before the first resin has had sufficient time to substantially cure, and preferably before there is any substantial polymerization of the first resin. This allows the first and second resins to combine or mix at the adjacent interior and exterior layers. Thus, a portion of the first resin may migrate into the exterior layer while a portion of the second resin may migrate into the interior layer. This migration of resin material reduces the likelihood of the formation of voids or zones of little or no resin material at the interface between the exterior layer and the interior layer. Voids or zones of little or no resin material tend to weaken the pultruded composite article and decrease its overall performance. In addition, infusion of the exterior reinforcement layer with the second resin prior to the first resin fully curing results in superior bonding of adjacent or interface interior and exterior layers. This superior bonding results because the different resin materials are allowed to mix with one another in the adjacent interior and exterior layers. If the first resin has substantially cured before application of the second resin, there is a risk that the bond between the adjacent interior and exterior layers will be somewhat less than desirable.

The exterior layer of polyurethane composite material may comprise from about 20 to about 85% by weight, or any amount therebetween, of reinforcement, for example 22, 24, 26, 28, 30, 32, 34, 36, 38, 40, 42, 44, 46, 48, 50, 52, 54, 56, 58, 60, 62, 64, 66, 68, 70, 72, 74, 76, 78, 80 and 82 weight percent, or any amount therebetween, and from about 15 to about 80% by weight, or any amount therebetween of the second resin, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76 and 78 weight percent, or any amount therebetween.

The second resin may comprise from about 20 to about 80% by weight, or any amount therebetween, of the isocyanate component, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween, and from about 20 to about 80% by weight, or any amount therebetween, of the polyol component, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween.

The isocyanate component of the second resin may comprise at least 15 weight percent of an aliphatic polyisocyanate to give the required characteristics of UV stability and abrasion resistance. The amount of aliphatic isocyanate in the isocyanate component may be from about 15 to about 100 weight percent or any amount therebetween, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76, 78 80, 82, 84, 86, 88, 90, 92, 94, 96, 98 and 100 weight percent, or any amount therebetween. Preferably the aliphatic isocyanate content of the isocyanate component is from about 30 to about 100 weight percent, or any amount therebetween, or from about 50 to about 100 weight percent or any amount therebetween. The present invention also contemplates that the only isocyanates present in the isocyanate component is an aliphatic isocyanates.

Other polyisocyanates may be present in the isocyanate component of the second resin, for example, from about 0% to about 40% by weight, or any amount therebetween, of an aromatic polyisocyanate, for example 2, 4, 6, 8, 10, 12, 14, 16, 18, 20, 22, 24, 26 28, 30, 32, 34, 36 and 38 weight percent, or any amount therebetween, provided that the concentration of aliphatic isocyanate in the isocyanate component is greater than the concentration of aliphatic isocyanate in the first resin.

The second resin may have a OH/NCO weight ratio from about 0.1:1 to about 5:1, or any amount therebetween, for example a ratio of 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2.0:1, 2.2:1, 2.4:1, 2.6:1, 2.8:1, 3.0:1, 3.2:1, 3.4:1, 3.6:1, 3.8:1, 4.0:1, 4.2:1, 4.4:1, 4.6:1, and 4.8:1, or any amount therebetween and preferably has a ratio from about 0.4:1 to about 1.5:1, or any amount therebetween, for example a ratio of 0.5:1, 0.6:1, 0.7:1, 0.8:1, 0.9:1, 1.1:1, 1.2:1, 1.3:1 and 1.4:1, or any amount therebetween.

The first resin may be made by mixing a polyol component and a polyisocyanate component to form a polyurethane resin. Other additives may also be included in the polyurethane resin of the first or second resin, such as fillers, pigments, plasticizers, curing catalysts, UV stabilizers, antioxidants, microbiocides, algaecides, dehydrators, thixotropic agents, wetting agents, flow modifiers, matting agents, deaerators, extenders, molecular sieves for moisture control and desired colour, UV absorber, light stabilizer and fire retardants.

By the term “aliphatic isocyanate” it is meant an isocyanate in which NCO groups are either attached to an aliphatic centre or not attached directly to an aromatic ring. It is also within the scope of the present invention that the term “aliphatic isocyanate” means an isocyanate in which the NCO groups are attached to an aliphatic centre. Aliphatic isocyanates described in U.S. Pat. No. 6,420,493 (which is incorporated herein by reference) may be used in the resin compositions described herein. Aliphatic isocyanates may include, but are not limited to, hexamethylene diisocyanate (HDI), isophorone diisocyanate (IPDI), dicyclohexane-4,4′ diisocyanate (Desmodur W), hexamethylene diisocyanate trimer (HDI Trimer), isophorone diisocyanate trimer (IPDI Trimer), hexamethylene diisocyanate biuret (HDI Biuret), cyclohexane diisocyanate, meta-tetramethylxylene diisocyanate (TMXDI), and mixtures thereof. The aliphatic isocyanate may include a polymeric aliphatic diisocyanate, for example, but not limited to a uretidione, biuret, or allophanate polymeric aliphatic diisocyanate, or a polymeric aliphatic diisocyanate in the symmetrical or asymmetrical trimer form, or a mixture thereof, which typically does not present a toxic hazard on account of extremely low volatility due to very low monomer content. The isocyanate component of the second polyurethane resin, used in the method of the present invention, may be hexamethylene diisocyanate (HDI), isophorone diisocyanate (IPDI) or a mixture thereof, and is preferably a mixture of aliphatic hexane 1,6-diisocyanato-homopolymer and hexamethylene diisocyanate (HDI). Hexamethylene diisocyanate polyisocyanates described in EP-A 668 330 to Bayer AG; EP-A 1002 818 to Bayer AG; and WO 98/48947 to Valspar Corp (which are incorporated herein by reference) may be used in the polyurethane resin composition described herein.

By the term “polyol” it is meant a composition that contains a plurality of active hydrogen groups that are reactive towards the polyisocyanate component under the conditions of processing. Polyols described in U.S. Pat. No. 6,420,493 may be used in the resin compositions described herein. The polyol component may include, but is not limited to, a polyether polyol, a polyester polyol, or a mixture thereof. The polyester polyol may be, but is not limited to a diethylene glycol-phthalic anhydride based polyester polyol. The polyether polyols may be, but is not limited to, polyoxyalkylene polyol, propoxylated glycerol, branched polyol with ester and ether groups, amine initiated-hydroxyl terminated polyoxyalkylene polyol and mixtures thereof.

By the term “aromatic isocyanate” it is meant an isocyanate in which NCO groups are attached to an aromatic ring. Aromatic isocyanates described in U.S. Pat. No. 6,420,493 may be used in the resin composition described herein. Aromatic isocyanates may include, but are not limited to, methylene di-p-phenylene isocyanate, polymethylene polyphenyl isocyanate, methylene isocyanatobenzene or a mixture thereof. The aromatic polyisocyanate may include from about 30% to about 60% by weight, or any amount therebetween, of methylene di-p-phenylene isocyanate, from about 30% to about 50% by weight, or any amount therebetween of polymethylene polyphenyl isocyanate, with a balance of methylene isocyanatobenzene.

By the term “composite material” it is meant a material composed of reinforcement embedded in a polymer matrix or resin, for example, but not limited to, polyester, epoxy, polyurethane, or vinylester resin or mixtures thereof. The matrix or resin holds the reinforcement to form the desired shape while the reinforcement generally improves the overall mechanical properties of the matrix.

By the term “reinforcement” it is meant a material that acts to further strengthen a polymer matrix of a composite material for example, but not limited to, fibres, particles, mats, cloths, veils, rovings or bundles of fibres, flakes, fillers, or mixtures thereof. Reinforcement typically comprises glass, carbon, or aramid, however there are a variety of other reinforcement materials, which can be used as would be known to one of skill in the art. These include, but are not limited to, synthetic and natural fibres or fibrous materials, for example, but not limited to polyester, polyethylene, quartz, boron, basalt, ceramics and natural reinforcement such as fibrous plant materials, for example, jute and sisal.

By the term “infuse” it is meant to saturate the voids and interstices of a reinforcement with a resin. The term “infuse” can be used interchangeably with the terms “impregnate”, “wetting” and “wet out” as are commonly used in the art.

The isocyanate component of the second resin may comprise at least 15 weight percent of an aliphatic isocyanate to give the required characteristics of UV stability and abrasion resistance. The amount of aliphatic isocyanate in the isocyanate component may be from about 15 to about 100 weight percent or any amount therebetween, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76, 78 80, 82, 84, 86, 88, 90, 92, 94, 96, 98 and 100 weight percent, or any amount therebetween. Preferably the aliphatic isocyanate content of the isocyanate component is from about 30 to about 100 weight percent, or any amount therebetween, or from about 50 to about 100 weight percent or any amount therebetween. The present invention also contemplates that the only isocyanates present in the isocyanate component may be aliphatic isocyanates.

The isocyanate component of the first polyurethane resin may comprise at least 20 weight percent of an aromatic isocyanate to give the desired strength characteristics. The amount of aromatic isocyanate in the isocyanate component of the first polyurethane resin may be from about 20 to about 100 weight percent or any amount therebetween for example 20, 22, 24, 26 28, 30, 32, 34, 36, 38, 40, 42, 44, 46, 48, 50, 52, 54, 56, 58, 60, 62, 64, 66, 68, 70, 72, 74, 76, 78 80, 82, 84, 86, 88, 90, 92, 94, 96, 98 and 100 weight percent, or any amount therebetween. Preferably the aromatic isocyanate content is from about 30-100 weight percent or any amount therebetween, or from about 40 to about 100 weight percent, or any amount therebetween. It is also contemplated that only isocyanate present in the isocyanate component of the first polyurethane resin may be aromatic isocyanate.

The polyol component may comprise from about 60 to about 100 weight percent polyether polyol, or any amount therebetween, for example 62, 64, 66, 68, 70, 72, 74, 76, 78, 80, 82, 84, 86, 88, 90, 92, 94, 96 and 98 weight percent, or any amount therebetween. The polyether polyol may have an equivalent weight between about 70 and about 2500, or any amount therebetween, for example, 100, 130, 160, 190, 220, 250, 280, 310, 340, 370, 400, 430, 460, 490, 520, 550, 580, 610, 640, 670, 700, 730, 760, 790, 820, 850, 880, 910, 940, 970, 1000, 1100, 1200, 1300, 1400, 1500, 1600, 1700, 1800, 1900, 2000, 2100, 2200, 2300, and 2400 or any amount therebetween, and preferably has an equivalent weight between about 70 and about 400, or any amount therebetween, and an hydroxyl functionality of between about 2 and about 6 or any amount therebetween, for example, 2.2, 2.4, 2.6, 2.8, 3.0. 3.2, 3.4, 3.6, 3.8, 4.0, 4.2, 4.4, 4.6, 4.8, 5.0, 5.2, 5.4, 5.6, and 5.8 or any amount therebetween.

The polyol component may comprise from about 0 to about 40 weight percent polyester polyol or any amount therebetween, for example 2, 4, 6, 8, 10, 12, 14, 16, 18, 20, 22, 24, 26, 28, 30, 32, 34, 36 and 38 weight percent, or any amount therebetween. The polyester polyol may have an equivalent weight between about 70 and about 1000, or any amount therebetween, for example, 100, 130, 160, 190, 220, 250, 280, 310, 340, 370, 400, 430, 460, 490, 520, 550, 580, 610, 640, 670, 700, 730, 760, 790, 820, 850, 880, 910, 940, 970, and 1000 or any amount therebetween, preferably has an equivalent weight between about 100 and about 300, or any amount therebetween, and an hydroxyl functionality of between about 2 and about 6 or any amount therebetween, for example, 2.2, 2.4, 2.6, 2.8, 3.0. 3.2, 3.4, 3.6, 3.8, 4.0, 4.2, 4.4, 4.6, 4.8, 5.0, 5.2, 5.4, 5.6, and 5.8 or any amount therebetween.

The polyurethane resin of the first or second resin utilized by the present invention may further comprise from about 2 to about 20 weight percent of a suitable chain extender, or any amount therebetween, for example 5, 7, 9, 11, 13, 15, 17, and 19 weight percent, or any amount therebetween. By the term “chain extender” it is meant a difunctional, low-molecular, multi-functional compound, which is reactive towards isocyanates. A suitable chain extender may have an equivalent weight between about 45 and about 400, or any amount therebetween, for example 70, 100, 130, 160, 190, 220, 250, 280, 310, 340, and 370 or any amount therebetween, and an hydroxyl functionality of at least 2. Preferably the chain extender employed in the resin comprises 1,4-butanediol.

The polyurethane resin of the first or second resin utilized by the present invention may also include known additives used in polyurethane pultrusion technology, for example, but not limited to, mould release agents, fillers, pigments or other colouring agents, plasticizers, curing catalysts, UV stabilizers, antioxidants, microbiocides, algaecides, dehydrators, thixotropic agents, wetting agents, flow modifiers, matting agents, deaerators, extenders, molecular sieves for moisture control and desired colour, UV absorber, light stabilizer, fire retardants or mixtures thereof. As hereinbefore describe in more detail, an aliphatic isocyanate polyurethane resin has superior resistance to UV rays. The UV stability can be further enhanced by addition of a UV stabilizer, a UV absorber, an antioxidant or a mixture thereof. Pot life of the resin can be adjusted by inclusion of a suitable catalyst, for example, but not limited to, a tin catalyst, bismuth catalyst, zinc catalyst, titanium catalyst or a mixture thereof. The pot life of the resin will mainly be determined however, by the temperature in the pultrusion reaction system.

The exterior layer of the pultruded composite article of the present invention may comprise between about 1 to about 90% of the thickness of the pultruded composite article with the interior layer comprises between about 10 to about 99% of the thickness of the pultruded composite article. In a preferred embodiment the exterior layer is thinner than the interior layer, for example the exterior layer may be between about 1 to about 49% thickness of the composite article. Provision of a thinner exterior layer comprising an aliphatic isocyanate polyurethane composite material, reduces the cost of production of the composite article as aliphatic isocyanate is typically more expensive that other isocyanates such as aromatic isocyanate.

More than two different resin compositions may be used in the pultrusion process to produce a composite article having a plurality of layers of different composite material, provided the exterior layer comprises an aliphatic isocyanate polyurethane composite material comprising from about 15 to about 100 weight percent, or any amount therebetween, aliphatic isocyanate polyurethane resin.

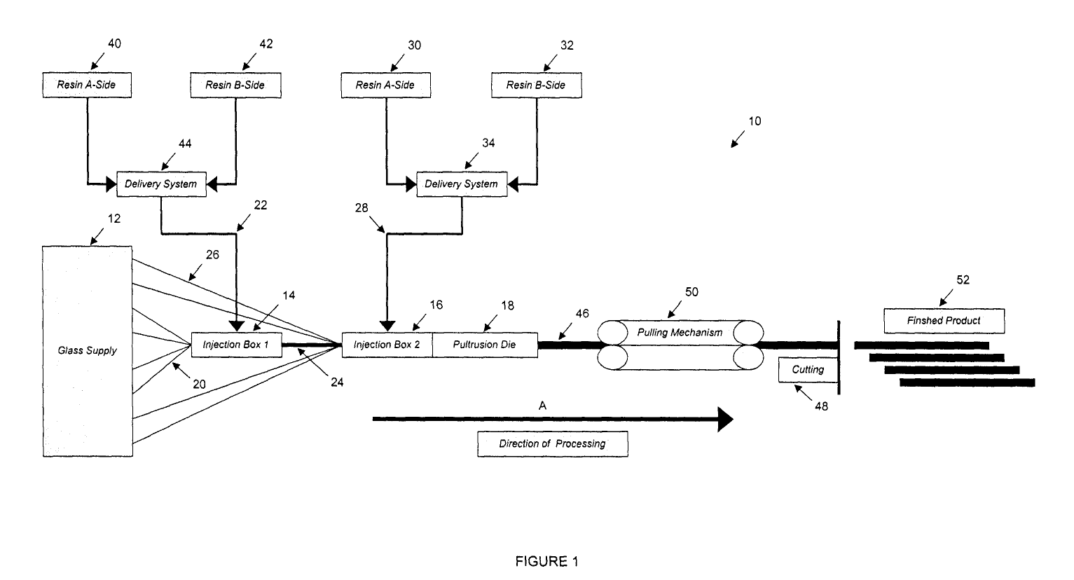

With reference to FIG. 1, there is shown schematically a pultrusion process 10 for forming a pultrusion product 52 using multiple resins. The process 10 includes a supply of continuous reinforcement 12, a first infusion die or box 14, a second infusion die or box 16, and a curing or curing die 18. The supply of continuous reinforcement 12 may be a spool of reinforcement, for example but not limited to reinforcing glass fibres, boron fibres, carbon fibres, ceramic fibres, synthetic fibres, natural fibres, and the like.

The pultrusion process 10 begins by supplying an interior layer of reinforcement 20, for example, but not limited to, a layer of continuous filament mats, rovings or veils of reinforcement. An example of a suitable interior reinforcement layer 20 is glass fibre (rovings and 31 oz/yd² mat) from Fiberex Glass Corporation and 1 oz/ft² mat from Owens Corning Fiberglass. The interior layer of reinforcement 20 is infused with a first resin 22 in first infusion box 14 to form an infused interior reinforcement layer 24. This process may also be referred to as “wetting” the reinforcement 20 with resin 22. Resin 22 may be any suitable thermosetting resin, for example, but not limited to a polyester, an epoxy, a vinylester, a polyurethane, or mixtures thereof. In a preferred embodiment first resin 22 comprises a two-part polyurethane resin as illustrated in FIG. 1. Although a first infusion box 14 is shown in FIG. 1, “wetting” or infusion of the interior reinforcement layer 20 may be carried out in an open bath containing first resin 22 or other infusion or impregnation structure known in the art.

Infused interior reinforcement layer 24 is combined with an exterior reinforcement layer 26 for example, but not limited to, a layer of continuous filament mats, rovings or veils of reinforcement, and passes into the second infusion box 16. An example of a suitable exterior reinforcement layer 26 is glass fibre (rovings and 31 oz/yd² mat) from Fiberex Glass Corporation and 1 oz/ft² mat from Owens Corning Fiberglass. The exterior reinforcement layer 26 is infused with a second resin 28 in the second infusion box 16 to form an infused pultrusion reinforcement structure (not shown) and then passes to the curing die 18.

The pultrusion process proceeds in direction A shown in FIG. 1, as a result of pulling mechanism 50, which acts to pull the interior layer of reinforcement 20 through first infusion box 14; the exterior reinforcement layer 26 combined with infused interior reinforcement layer 24 through second infusion box 16; and the infused pultrusion reinforcement structure through curing die 18. As the infused pultrusion reinforcement structure passes though curing die 18, resins 22, 28 cure, and a cured composite material 46 is produced and cut into a plurality of finished products 52 by a cutter 48. The curing die 18 may be heated to a temperature of about 150° C. to about 250° C., or any temperature therebetween, to enhance curing or setting of resins 22, 28 in the curing die 18.

Second resin 28 comprises a aliphatic polyurethane resin and may be formed by mixing resin precursors comprising two resin components contained in separate vessels (e.g. second Resin A-side 30, and second Resin B-side 32), which are mixed in a second delivery system 34 and delivered to second infusion box 16. Supply pumps (not shown) may be provided to supply the resin precursors in a suitable ratio to the second delivery system 34. For example, second Resin A-side 30 may comprise a polyol component and a catalyst and second Resin B-side 32 may comprise an aliphatic isocyanate component, supplied in an OH/NCO weight ratio from about 0.1:1 to about 5:1 (preferably from about 0.4:1 to about 1.5:1), or any amount therebetween. Two component aliphatic isocyanate polyurethane resins suitable to be used as second resin 28 include resin compositions I, II and III given in the Examples herein.

First resin 22 may also be formed by mixing resin precursors contained in separate vessels (e.g. first Resin A-side 40, and first Resin B-side 42), which are mixed in a first delivery system 44 and delivered to first infusion box 14. Supply pumps (not shown) may be provided to supply the resin precursors in a suitable ratio to the first delivery system 44. For example, first Resin A-side 40 may comprise a polyol component and a catalyst and first Resin B-side 42 may comprise an aromatic isocyanate component, supplied at an OH/NCO weight ratio from about 0.1:1 to about 5:1 (preferably from about 0.4:1 to about 1.5:1), or any amount therebetween. An example of a two component chemically thermoset polyurethane composite resins suitable to be used as first resin 22 is resin composition IV given in the Examples herein.

The two component polyurethane resin once mixed together may have a gel time of between about 1 to about 30 minutes at room temperature. This allows thorough mixing of Resin A and Resin B in delivery system 34, 44 and proper “wetting” or infusion of reinforcement layers 20, 26 in infusion box 14, 16, before polymerization of the polyurethane resin takes place.

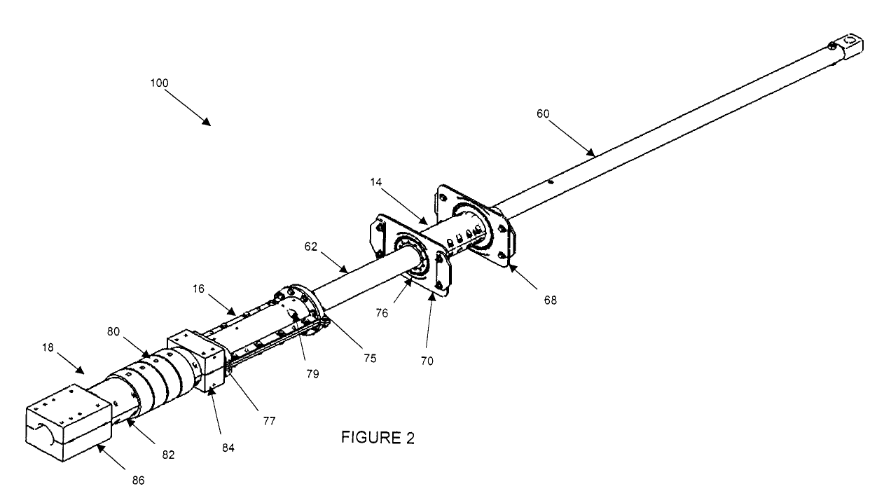

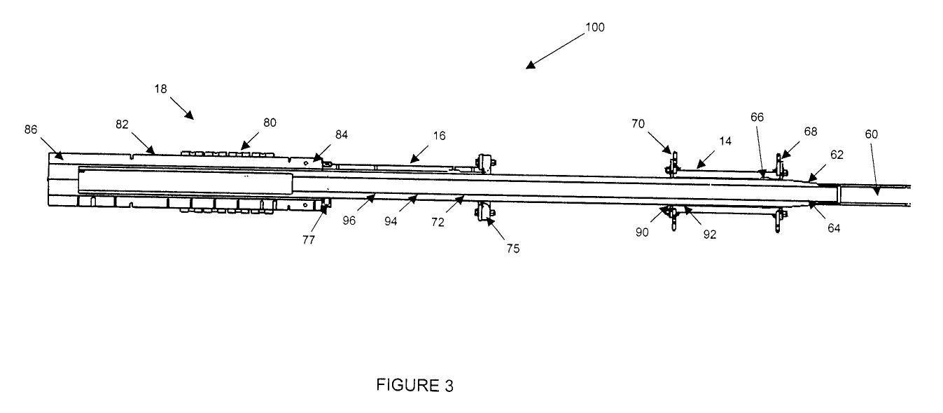

Referring to FIGS. 2 and 3, there is shown an example of a pultrusion apparatus 100 that can be used in the pultrusion method of the present invention. The apparatus 100 comprises a mandrel 60 upon which is positioned the first infusion box 14, the second infusion box 16 and the curing die 18. The mandrel 60 may span most of the length of the apparatus 100 and may comprise an outer surface 62 with a hollow core 64.

First infusion box 14 spans the mandrel 60 with a gap 90 between the mandrel outer surface 62 and an inner surface 92 of first infusion box 14, which is typically about 0.5 mm to about 20 mm in width, or any width therebetween, for example about 2 mm to about 7 mm, to accommodate the interior reinforcement layer 20 fed into first infusion box 14.

A weir 66 is positioned between the mandrel outer surface 62 and inner surface 92. First resin 22 is injected into weir 66 to allow the resin 22 to flow completely around the reinforcement 20 passing through infusion box 14. The moving reinforcement 20 pulls resin 22 from the weir 66, and as the reinforcement 20 moves through the infusion box 14, the first resin 22 is infused into the interior reinforcement layer 20.

An entrance squeeze plate 65 may be provided at the entrance of first infusion box 14. The squeeze plate 65 is sized to squeeze the interior reinforcement layer 20 when it enters the first infusion box 14, such that the total volume between the mandrel outer surface 62 and the first infusion box inner surface 92 is reduced by about 3 to about 10% or any amount therebetween, from the entrance to the exit of squeeze plate 75 and into the rest of infusion box 16. Typically, the volume is reduced by about 5%; lower than 5% squeeze can result in excessive resin leakage and poor wet out, while higher than 5% squeeze may rip the reinforcement and can also lead to poor wet out. The volume fraction of the interior reinforcement layer 20 in the first infusion box 14 may be between about 20 to about 70% of the total volume of material in the box 14, or any amount therebetween, and is typically between about 40 to about 55%, for example between about 45 to about 50%.

A first carding plate 68 is provided to direct the exterior reinforcement layer 26 over first infusion box 14 and a second carding plate 70 is provided to direct the exterior reinforcement layer 26 into the second infusion box 16. The first and second carding plates 68, 70 may be made of any suitable material, for example steel, which is stiff, strong, and can be welded readily if required. Holes and slots 76 may be drilled in the carding plates 68, 70 in the same pattern as the part shape. More than two carding plates may be provided, spaced such that the reinforcement 20, 26 do not sag and become tangled during operation. Reinforcement 20, 26 may be strung through the carding plates 68, 70 in an organized pattern, to allow for equal distribution of the reinforcement. The pattern of holes and slots 76 in each successive carding plate typically decreases, ending in a final carding plate 70 that guides all of the reinforcement 20, 26 into the second infusion box 16.

The first resin delivery system 44 is connected to the first infusion box 14 for delivery of the first resin 22 to infuse interior reinforcement layer 20 and form infused interior reinforcement layer 24 exiting first infusion box 14. The infused interior reinforcement layer 24 is combined with exterior reinforcement layer 26 to form a pultrusion reinforcement structure before passing into second infusion box 16.

Second infusion box 16 may be made up of two aluminium halves bolted together to span the mandrel 60. Gaskets and sealant (for example, Loctite 5900 Flange Sealant) may be used to eliminate leakage between the two halves of the infusion box 16. Socket cap bolts may be used to create a tight fit and precise alignment between the second infusion box 16 and curing die 18. The infusion box is sized to provide a gap 94 between the mandrel outer surface 62 and an inner surface 96 of second infusion box 16, which is typically about 1 mm to 25 mm in width, or any width therebetween, for example between about 5 mm to about 15 mm, to accommodate the infused interior reinforcement layer 24 combined with exterior reinforcement layer 26 fed into the second infusion box 16. Gap 94 is typically wider than gap 90, as more material (i.e. the infused interior reinforcement layer 24 and exterior reinforcement layer 26) is passing through the second infusion box 16 than the first infusion box 14 (which only receives the interior reinforcement layer 20).

A weir 72 is positioned between the mandrel outer surface 62 and inner surface 96. Second resin 28 is injected into weir 72 to allow the resin 28 to flow completely around the exterior reinforcement layer 26 passing through infusion box 14. The moving reinforcement 26 pulls resin 28 from the weir 72, and as the reinforcement 26 moves through the second infusion box 16, the second resin 28 is infused into the exterior reinforcement layer 26.

An entrance squeeze plate 75 is provided at the entrance of second infusion box 16. The squeeze plate 75 is sized to squeeze the pultrusion reinforcement structure when it enters the second infusion box 16, such that the total volume between the mandrel outer surface 62 and the infusion box inner surface 96 is reduced by about 3 to about 10% or any amount therebetween, from the entrance to the exit of squeeze plate 75 and into the rest of infusion box 16. Typically, the volume is reduced by about 5%; lower than 5% squeeze can result in excessive resin leakage and poor wet out, while higher than 5% squeeze may rip the reinforcement and can also lead to poor wet out. The volume fraction of reinforcement 20, 26 in the second infusion box 16 may be between about 40 to about 80% of the total volume of material in the box 16, or any amount therebetween, and is typically between about 55 to about 65%, for example between about 60 to about 63%.

Second infusion box 16 has one or more infusion points 74 for infusion of second resin 28 from second delivery system 34. Infusion ports are typically positioned near the entrance of the infusion box 16, so as to achieve proper resin flow and reduce the possibility of resin build-up in the box 16, which can lead to premature curing in the infusion box 16. In other words, the “old” resin is carried away from the entrance of the box by the pultrusion reinforcement structure, and as “new” resin is pumped in to box 16, it continually soaks the dry exterior reinforcement layer 26.

Second resin 28 is typically injected under pressure to ensure complete infusion of the exterior reinforcement layer 26 to form the infused pultrusion reinforcement structure. The system utilizes back pressure generated by squeezing the exterior reinforcement layer 26 to allow for high pressure resin infusion. In other words, the infusion box inner diameter or gap 94 is sized such that the exterior reinforcement layer 26 is “squeezed” throughout the length of the infusion box 16, which in turn creates a substantial back pressure (or resistance to resin back flow) towards the entrance of the box 16. In addition, the entrance squeeze plate 75 is utilized to maximize the backpressure at the entrance of the infusion box 16.

The second infusion box 16 may have a cooling section 77 positioned at the end of the box adjacent the curing die 18.

Pultrusion or curing die 18 may be made of two halves bolted together to span mandrel 60 and comprises an entry zone 84, a reaction zone 82 and an exit zone 86. The die 18 may be made of any suitable heat transfer material, such as, but not limited to steel. The inner surface of the die may be coated with a layer of material that is resistant to wearing, such as, but not limited to chrome. The infused pultrusion reinforcement structure passes through entry zone 84 after exiting second infusion box 16 and into reaction zone 82. One or more heating bands 80 may be provided to heat reaction zone 82 to a peak temperature of about 150° C. to about 270° C., or any temperature therebetween, for example about 190° C. to about 240° C. The heating bands may be made of any suitable material that can be heated, for example, but not limited to ceramic. The temperature profile of heating zone 82 may be characterized by a steep increase in temperature, up to the peak temperature, followed by steady, gradual cooling into the exit zone 86. The heated reaction zone 82 may be thermally isolated from entry zone 84 and exit zone 86. Additionally, the entry zone 84 and/or exit zone 86 may be configured for providing cooling if desired, for example, entry zone 84 may be water cooled to a temperature of less than about 40° C. and exit zone 86 may be cooled using cooling blocks to a steady temperature of about 80° C. to about 150° C., or any temperature therebetween, for example about 100° C. to about 130° C.

Second infusion box 16 is preferably sealingly coupled or integrally formed with the curing die 18. Thus, as the infused pultrusion reinforcement structure leaves the infusion box 16, it directly enters the curing die 18 without being exposed to the surrounding environment. Further, the infused pultrusion reinforcement structure is constantly maintained under pressure as it moves from the infusion box 16 into the curing die 18.

Multiple resin materials may be applied to different sets of layers within the infused pultrusion reinforcement structure to impart differing properties across the final product, provided the outer layer is infused with a resin comprising an aliphatic isocyanate polyurethane. Of course one of ordinary skill in the art will recognize that when the interior reinforcement layers 20 are divided into separate sub-layers, each to be separately pre-infused with the same or different resin, an equivalent number of infusion means (such as, but not limited to, an infusion box, injection box or open bath) will be required. Thus, three interior layers to be separately pre-infused will require three infusion means and so forth. If infusion boxes are utilized, the “dry” reinforcement layer entering the box (i.e. the exterior layer of reinforcement added to the pultrusion reinforcement structure) is suitably less than about 5 mm in thickness, to provide proper wetting (infusion) of the reinforcement layer in the infusion box. Resin materials of either the same or differing compositions may be provided to the infusion means as described above. Further, if so desired, multiple infusion means may be provided in series. For instance, an interior layer may be infused in a first infusion box with a first resin material then in a second infusion box located downstream from the first infusion box with a different resin material.

The composite article of the present invention may be a utility pole, however, the composite article is not limited to a utility pole and may include other structural articles, for example, posts, scaffolding, fencing materials, building materials, or other articles that may be used in an outdoor setting or may be subjected to UV exposure, for example, but not limited to, car bumpers, window frames, guttering, window lineals, soffets, eave and eave troughs (any product with a consistent cross section to be used in an out door application) ski poles, golf club shafts, flag poles, antennae, moulding, weather stripping, building siding. A composite article comprising an aliphatic isocyanate composite outer layer may be subjected to prolonged sand blasting and UV exposure without showing any significant degradation of physical and mechanical properties indicating UV stability and abrasion resistance.

The present invention will be further illustrated in the following examples. However, it is to be understood that these examples are for illustrative purposes only, and should not be used to limit the scope of the present invention in any manner.

### EXAMPLES

In the Examples that follow all percentages given are percentages by weight unless indicated otherwise.

The following materials were used in the Examples:

POLYISOCYANATE A: A HDI Hexane, 1,6-diisocyanato-, homopolymer polyisocyanate having an NCO content of 23% and a viscosity ranging between 900-1500 cps, which is commercially available from Rhodia under the name Tolonate HDT-LV™
POLYISOCYANATE B: A HDI Hexane, 1,6-diisocyanato-, homopolymer polyisocyanate having an NCO content of 23% and a viscosity ranging between 450-750 cps, which is commercially available from Rhodia under the name Tolonate HDT-LV2 ™
POLYISOCYANATE C: A mixture of polyisocyanate, polymeric hexamethylene diisocyanate, and less than 5% monomeric 1, 6 Hexamethylene Diidocyanate based Polyisocyanate, having an NCO content of 23% and a viscosity of about 1200 cps, which is commercially available from Bayer material Science LLC under the name of Desmodur N3600™.
POLYISOCYANATE D: A polymeric MDI, Polymethylene polyphenyl isocyanate containing 4,4′-Methylene bisphenyl isocyanate, having an NCO content of at least 32% and a viscosity of about 200 cps, which is commercially available from Dow Chemicals under the name of PAPI 27™.
POLYOL A: A polyether polyol having an equivalent weight of about 86 and a functionality of 3.0 which is commercially available from Arch under the name PolyG 76-635™
POLYOL B: A polyether polyol having an equivalent weight of about 100 and functionality of 4.0 which is commercially available from BASF under the name Pluracol PEP 450™
POLYOL C: A polyether polyol having an equivalent weight of about 212 and a functionality of 2.0 which is commercially available from Arch under the name PPG 20-265™.
POLYOL D: A polyester polyol having an equivalent weight of about 142 and a functionality of 2.0 which is commercially available from Stephan Company under the name Stepanpol® PS-20-200A™
POLYOL E: A polyester polyol having an equivalent weight of about 288 and a functionality of about 2.0 which is commercially available from Stephan Company under the name Stepanpol® PS 20-200A™
CATALYST A: A tin catalyst which is commercially available from Goldschmidt Industrial Chemicals under the name Tegokat 218™
CHAIN EXTENDER A: 1,4 Butanediol, available from BASF.
UV SYSTEM A: A liquid light stabilizer system comprising a synergistic blend of a light stabilizer, a light absorber and an antioxidant, commercially available from CIBA under the name Tinuvin B75™
UV SYSTEM B: A blend of a liquid hindered light stabilizer commercially available from CIBA under the name Tinuvin 765™ and a liquid benzotriazole light absorber commercially available from CIBA under the name Tinuvin 571™
COLOUR A: Grey colorant commercially available from POLYONE under the name STANTONE HCC™ Gray
COLOUR B: Blend of 50% by weight of COLOUR A with the remainder comprising a 1:1 ratio mixture of Rebus Dark grey 2180™ (available from REBUS) and Colormatch Metal LDR™ (available from Plasticolor).
COLOUR C: Rebus grey 70165™ (available from REBUS)
MOLECULAR SIEVE A: Purmol 3ST™ (available from ZEOCHEM)
MOLECULAR SIEVE B: Siliporite SA 1720™ (available from ARKEMA Canada Inc)
MOLECULAR SIEVE C: Molsiv® Adsorbent Type 3A™ (available from UOP LLC)
INTERNAL MOLD RELEASE A: INT-1945MCH™ (available from Axel)

### Aliphatic Isocyanate Polyurethane Resin Composition I

An aliphatic isocyanate polyurethane resin composition (composition I) was made up by mixing polyol component A and POLYISOCYANATE C in an OH/NCO weight ratio of 1.00:1.82, wherein polyol component A had the following composition:

### Polyol Component A:

80 parts by weight of POLYOL B
5.5 parts by weight of POLYOL C
3 parts by weight of MOLECULAR SIEVE A
3 parts by weight of COLOUR B
0.5 part by weight of UV SYSTEM B
2 parts by weight CATALYST A
6 parts by weight MOLD RELEASE A
Total: 100 parts

Resin composition I had a pot life of about 20 minutes when started at 25° C. However, it will be evident to a person skilled in the art that the composition may be modified and refined in various ways. Resin composition I is suitable for infusion of the exterior reinforcement layer in the method of the present invention.

### Aliphatic Isocyanate Polyurethane Resin Composition II

An aliphatic isocyanate polyurethane resin composition (composition II) was made up by mixing polyol component B and POLYISOCYANATE B in an OH/NCO weight ratio of 1.00:1.43, wherein polyol component B had the following composition:

### Polyol Component B:

65 parts by weight of POLYOL A
12 parts by weight of CHAIN EXTENDER A
11 parts by weight of POLYOL D
2 parts by weight of COLOUR A
3 parts by weight of MOLECULAR SIEVE B
1 part by weight of UV SYSTEM B
6 parts by weight MOLD RELEASE A
0.7 parts by weight of CATALYST A
Total: 1 parts

Composition II had a pot life of about 20 minutes when started at 25° C. However, it will be evident to a person skilled in the art that the composition may be modified and refined in various ways. Resin composition II is suitable for infusion of the exterior reinforcement layer in the method of the present invention.

### Aliphatic Isocyanate Polyurethane Resin Composition III

An aliphatic isocyanate polyurethane resin composition (composition III) was made up by mixing polyol component C and POLYISOCYANATE A in an OH/NCO weight ratio of 1.00:2.72, wherein polyol component C had the following composition:

### Polyol Component C

86 parts by weight of POLYOL A
3 parts by weight of MOLECULAR SIEVE B
6 parts by weight MOLD RELEASE A
3 parts by weight COLOR C
1.5 parts CATALYST A
Total: 100 parts

Composition III had a pot life of about 20 minutes when started at 25 C. However, it will be evident to a person skilled in the art that the pot life may be modified and refined in various ways by adjusting the amount of catalyst. Resin composition III is suitable for infusion of the exterior reinforcement layer in the method of the present invention.

### Aromatic Isocyanate Polyurethane Resin Composition IV

Aromatic isocyanate polyurethane resin composition IV was made by mixing polyol component D with POLYISOCYANATE D in an OH/NCO weight ratio of 1.00:1.12, wherein polyol component D had the following composition:

### Polyol Component D:

51 parts by weight of POLYOL A
25 parts by weight of POLYOL C
17 parts by weight of POLYOL E
4 parts by weight of INTERNAL MOLD RELEASE A
3 parts by weight of MOLECULAR SIEVE A
0.2 parts by weight of CATALYST A
Total: 100 parts

Aromatic isocyanate polyurethane resin composition IV had a pot life of about 20 minutes when started at 25C. However, it will be evident to a person skilled in the art that the pot life may be modified and refined in various ways by adjusting the amount of catalyst. Resin composition IV is suitable for infusion of the interior reinforcement layer in the method of the present invention.

All references are herein incorporated by reference.

In this patent document, the word “comprising” is used in its non-limiting sense to mean that items following the word are included, but items not specifically mentioned are not excluded, in other words the term “comprising” is substantially equivalent to the phrase “including but not limited to”, and the word “comprises” has a corresponding meaning. A reference to an element by the indefinite article “a” does not exclude the possibility that more than one of the element is present, unless the context clearly requires that there be one and only one of the elements.

The present invention has been described with regard to preferred embodiments. However, it will be obvious to persons skilled in the art that a number of variations and modifications can be made without departing from the scope of the invention as described herein. Citation of references is not an admission that such references are prior art to the present invention.

What is claimed is:

1. A method of manufacturing a composite article by pultrusion comprising:
supplying a continuous interior reinforcement layer and a continuous exterior reinforcement layer;
infusing the interior reinforcement layer with a first resin to form an infused interior reinforcement layer;
combining the infused interior reinforcement layer with the exterior reinforcement layer to form a pultrusion reinforcement structure;
passing the pultrusion reinforcement structure into an infusion die and infusing the exterior reinforcement layer of the pultrusion reinforcement structure with a second resin to form an infused pultrusion reinforcement structure; and
passing the infused pultrusion reinforcement structure to a curing die to cure the first and second resin in the infused pultrusion reinforcement structure to form a composite article;
wherein the second resin comprises a polyurethane resin comprising a polyol component and an isocyanate component, and the concentration of aliphatic isocyanate in the isocyanate component is greater than the concentration of aliphatic isocyanate in the first resin.

2. The method of claim 1, wherein the step of passing the pultrusion reinforcement structure into the infusion die comprises the steps of shaping and compressing the pultrusion reinforcement structure.

3. The method of claim 1, wherein the curing die is sealingly coupled to the infusion die and in the step of passing the infused pultrusion reinforcement structure to the curing die the infused pultrusion reinforcement structure is maintained under compression.

4. The method of claim 1, wherein the step of infusing the interior reinforcement layer with the first resin comprises passing the interior reinforcement layer into a further infusion die and infusing the interior reinforcement layer with the first resin to form the infused interior reinforcement layer.

5. The method of claim 4, wherein the step of passing the interior reinforcement layer into the further infusion die comprises the steps of shaping and compressing the interior reinforcement layer.

6. The method of claim 1, wherein the first resin comprises from about 20 to about 80% by weight of an aromatic polyisocyanate and from about 20 to about 80% by weight of a first polyol, and the second resin comprises from about 20 to about 80% by weight of an aliphatic polyisocyanate and from about 20 to about 80% by weight of a second polyol.

7. The method of claim 6, wherein the aliphatic polyisocyanate comprises hexamethylene diisocyanate (HDI), isophorone diisocyanate (IPDI) or a mixture thereof.

8. The method of claim 6, wherein the aliphatic polyisocyanate comprises a mixture of aliphatic hexane 1,6-diisocyanato-homopolymer and hexamethylene diisocyanate (HDI).

9. The method of claim 6, wherein the first and second polyol comprises from about 60 to about 100% by weight of a polyether polyol and from about 0 to about 40% by weight of a polyester polyol

10. The method of claim 9, wherein the polyether polyol has an equivalent weight in the range from about 70 to about 2500 and an hydroxyl functionality equal to or greater than about 2.

11. The method of claim 9, wherein the polyether polyol has an equivalent weight in the range from about 70 to about 400 and an hydroxyl functionality in the range from about 2 to about 6.

12. The method claim 9, wherein the polyester polyol has an equivalent weight in the range from about 70 to about 1000 and a hydroxyl functionality equal to or greater than about 2.

13. The method of claim 9, wherein the polyester polyol has an equivalent weight in the range from about 100 to about 300 and an hydroxyl functionality in the range from about 2 to about 6.

14. The method of claim 1, wherein the second resin further comprises a catalyst selected from the group consisting of tin, bismuth, zinc, titanium and a mixture thereof.

15. A pultruded composite article comprising an interior layer of a first composite material and an exterior layer of a second composite material, the concentration of aliphatic isocyanate in the second composite material being greater than the concentration of aliphatic isocyanate in the first composite material.

16. The composite article of claim 15 produced using the method of claim 1.

17. The composite article of claim 16 comprising a utility pole.
